(19) United States
(12) Patent Application Publication
(10) Pub. No.: US 2011/0046922 A1
(43) Pub. Date: Feb. 24, 2011

(54) METHOD FOR DESIGNING A LIGHT GUIDE PLATE

(75) Inventors: HE ZHANG, Beijing (CN); JUN ZHU, Beijing (CN); YAN ZHAO, Beijing (CN); GUO-FAN JIN, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: TSINGHUA UNIVERSITY, Beijing (CN); HON HAI PRECISION INDUSTRY CO., LTD., Tu-Cheng (TW)

(21) Appl. No.: 12/624,397

(22) Filed: Nov. 23, 2009

(30) Foreign Application Priority Data
Aug. 18, 2009 (CN) 200910189606.3

(51) Int. Cl. G06F 17/50

(52) U.S. Cl. 703/1

(57) ABSTRACT

The present disclosure relates to a method for designing a light guide plate. A raw light guide plate having a light input surface and light output surface opposite to the light input surface is provided. An illuminating surface having a shape and area same to that of the light output surface is built. The illuminating surface is divided into n×m illuminating areas, and the light input surface is divided into n×m scattering dots distributing areas corresponding to n×m illuminating areas. A number of original scattering dots are distributed on each scattering dots distributing areas. The original scattering dots are optimized.

### RELATED APPLICATIONS

This application claims all benefits accruing under 35 U.S.C. §119 from China Patent Application No. 200910189606.3, filed on Aug. 18, 2009 in the China Intellectual Property Office.

### BACKGROUND

1. Technical Field

The present disclosure relates to a method for designing a light guide plate.

2. Description of Related Art

Currently, liquid crystal displays (LCDs) are extensively used in a variety of electronic devices because they are thin, lightweight, long lasting, and consume little power. However, backlight modules are typically required because liquid crystals are not self-luminescent. Generally, backlight modules can be categorized as either direct-type backlight modules or edge-type backlight modules according to the placement of the light sources. The direct-type backlight modules are more widely employed in numerous applications because direct-type backlight modules can provide high illumination in comparison with edge-type backlight modules.

A light guide plate is a core component in a backlight module to convert a linear light source or a point light source into a planar light source with good illuminance uniformity. A light guide plate for a direct-type backlight module according to a related art includes a top surface, a light input surface opposite to the top surface, and at least one side connecting the light input surface and the top surface. At least one of the light input surface and the top surface includes a plurality of scattering dots. The distribution of the scattering dots on a corresponding surface of the light guide plate remarkably affects the illuminance uniformity and efficiency of the light guide plate. However, in the related art, the distribution of the scattering dots on the surface of the light guide plate does not provide uniform light output from the light guide plate, thereby reducing the uniformity of illumination of the direct-type backlight module.

What is needed, therefore, is to provide a method for designing a light guide plate which has an improved uniformity of illumination.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout several views.

FIG. 1 is a flow chart of one embodiment of a method for designing a light guide plate.

FIG. 2 is a schematic view of a raw light guide plate without scattering dots.

FIG. 3 is a schematic view of scattering dots of a light guide plate designed by the method of FIG. 1.

FIG. 4 is a flow chart of a step of optimizing the original scattering dots of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

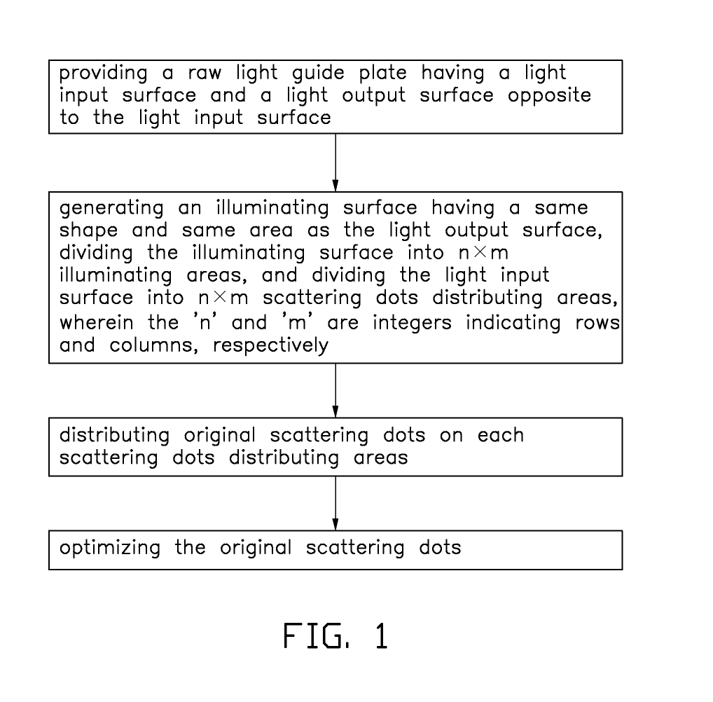

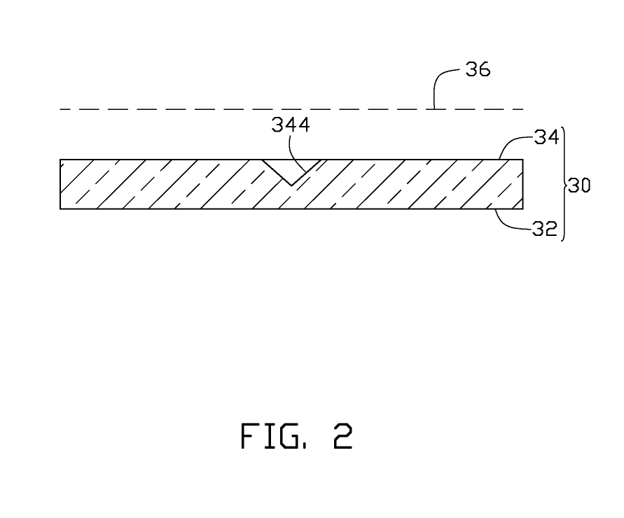

Referring to FIG. 1 to FIG. 3, a method for designing a light guide plate includes:

(a) providing a raw light guide plate 30 having a light input surface 32 and a light output surface 34 opposite to the light input surface 32;

(b) generating an illuminating surface 36 having a same shape and same area as the light output surface 34, dividing the illuminating surface 36 into n×m illuminating areas (not shown), and dividing the light input surface 32 into n×m scattering dots distributing areas 320, wherein the ‘n’ and ‘m’ are integers indicating rows and columns, respectively;

(c) distributing original scattering dots (not labeled) on each scattering dots distributing areas 320; and

(d) optimizing the original scattering dots.

In step (a), the raw light guide plate 30 is a transparent plate and can have a round, square, rectangle, polygon, or other shape. The thickness and size of the raw light guide plate 30 are arbitrary and can be selected according to need. The raw light guide plate 30 may be made of plastic, polymethyl methacrylate (PMMA), polycarbonate

(PC), or glass. The light output surface 34 is opposite and substantially parallel to the light input surface 32. The raw light guide plate 30 can be used in a direct-type backlight module or an edge-type backlight module.

In one embodiment, the raw light guide plate 30, to be used in a direct-type backlight module, is a square PMMA plate having a side length of about 40 millimeters, a thickness of about 3 millimeters, and a refractive index of about 1.49. A reflecting recess 344 is defined in the raw light guide plate 30 at the center of the light output surface 34. In one embodiment, the reflecting recess 344 is a cone-shaped pit. The cross-sectional area of the reflecting recess 344 gradually increases from the light input surface 32 to the light output surface 34. A diameter of the cone-shaped pit at the light output surface is about 7 millimeters in one embodiment. When the raw light guide plate 30 is used in an edge-type backlight module, the reflecting recess 344 is not needed.

In step (b), the illuminating surface 36 can be the light output surface 34 or an imaginary surface spaced apart from the light output surface 34. When the illuminating surface 36 is the imaginary surface spaced apart from the light output surface 34, the orthographic projection of the illuminating surface 36 overlaps the light output surface 34. A size of each scattering dots distributing areas 320 can be same or different. The shape of the scattering dots distributing areas 320 is arbitrary, such as a square, rectangular, or parallelogram shape. The orthographic projection of the illuminating areas of the illuminating surface 36 overlaps the scattering dots distributing areas 320 of the light input surface 32. The illumination distribution of the illuminating areas of the illuminating surface 36 can indicate the uniformity of light output.

In one embodiment, the illuminating surface 36 is substantially parallel to and spaced about 10 millimeters apart from the light output surface 34. A shape and size of the illuminating surface 36 is about the same as that of the light output surface 34. The illuminating surface 36 is divided into n×m illuminating areas, where ‘n’ and ‘m’ are equal to 10. Namely, the illuminating surface 36 is divided into 100 square illuminating areas having the same shape and size. Accordingly, the light input surface 32 is divided into 100 square scattering dots distributing areas 320 having the same shape and size. Therefore, the shape and size of the illuminating areas is about the same as that of the scattering dots distributing areas 320.

In step (c), the original scattering dots can be distributed on the scattering dots distributing areas 320 randomly, uniformly, or and predetermined fashion. The number of the original scattering dots on each of the scattering dots distributing areas 320 can be the same or different. When the original scattering dots are distributed according to a predetermined fashion, the original scattering dots can be distributed to form a plurality of shapes concentrically located around a center of each of the scattering dots distributing area 320.

An additional step (e) of illuminating simulation can be carried out before step (c) of distributing the original scattering dots, to determine the original illumination distribution of the illuminating surface 36. Thus, the original scattering dots can be distributed according to the original illumination distribution of the illuminating surface 36.

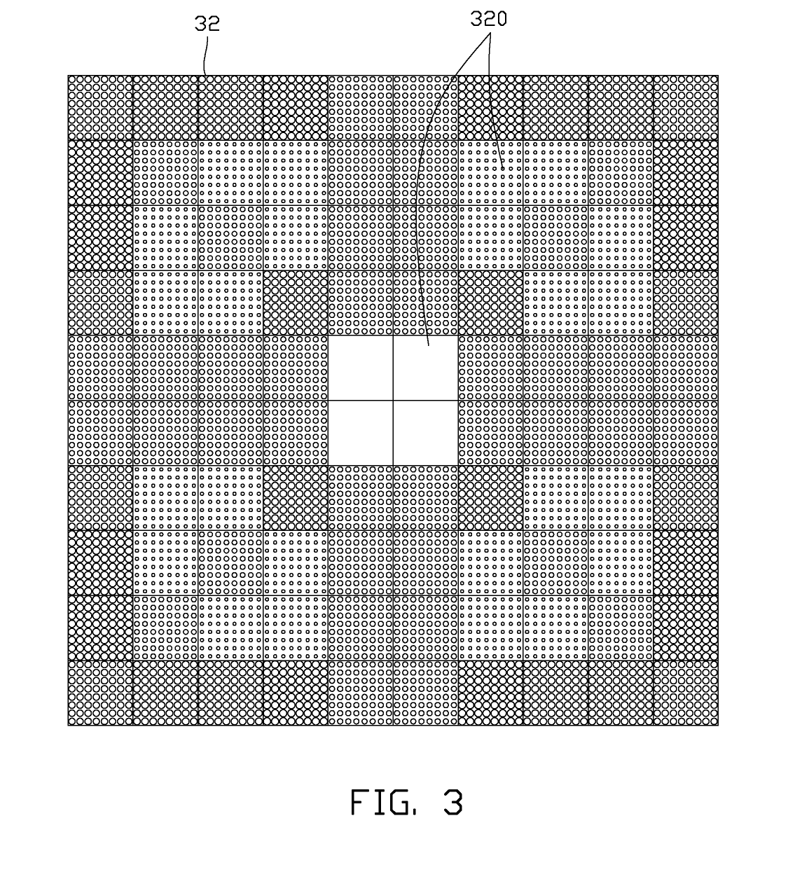

In one embodiment, the 8×8 original scattering dots are distributed on each of the scattering dots distributing areas 320 except for four scattering dots distributing areas 320 located in the center of the light input surface 32 and opposite to the reflecting recess 344 as shown in FIG. 3.

The original scattering dots can be protrusions, pits, or a combination thereof. The shape of the original scattering dots can be cubic, cuboid, spherical, or hemispherical. Effective diameters of the original scattering dots can be less than about 0.5 millimeters. Also, the original scattering dots can be a planar structure such as triangular, square, rhombic, round, or a combination thereof. The original scattering dots can be made of ink, Ti-related materials, or a Si compound. In one embodiment, the original scattering dots are round ink spots with a diameter of about 0.3 millimeters.

Step (d) can include the following substeps of:

(d1) determining the illumination distribution of the illuminating surface 36;

(d2) evaluating; and

(d3) adjusting the original scattering dots on the corresponding scattering dots distributing areas 320 according to the evaluation.

In step (d1), the illumination distribution can be determined by illuminating simulations on a computer. The step (d1) can include the following substeps of: (d11) determining the illumination of each of the illuminating areas; and (d12) calculating the mean value of the illumination and the difference in value between the mean value of the illumination and the illumination of each of the illuminating areas.

In step (d3), the original scattering dots can be adjusted by adding or reducing the original scattering dots, changing the shape, size or material of the original scattering dots, or moving the original scattering dots. The difference in value between the mean value of the illumination and the illumination of each of the illuminating areas should be minimized to improve the uniformity of illumination. In one embodiment, the original scattering dots are round ink spots and the diameter of the original scattering dots is changed to achieve optimization.

Once the original scattering dots are distributed, the original scattering dots can be continuously optimized to improve illumination uniformity. In one embodiment, the mean value of the illumination of the illuminating surface 36 is about 500 luces and the uniformity of illumination is about 80%. Namely, the uniformity of illumination of the light output surface 34 is about 80%.

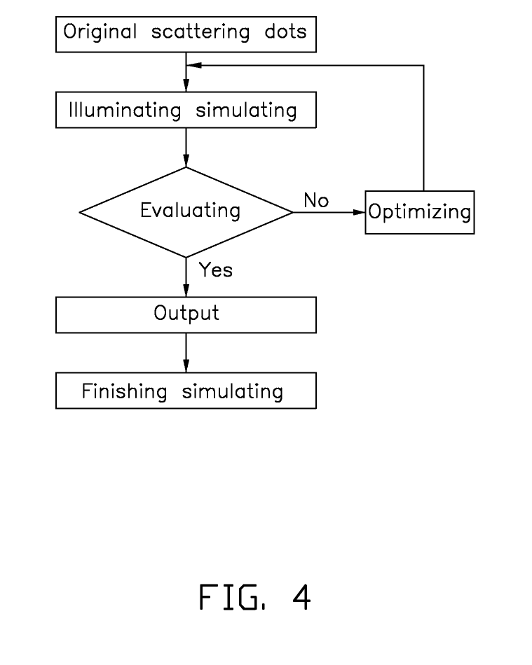

The method for designing a light guide plate 30 can be performed by computer simulation. Referring to FIG. 4, the step (d) of optimizing the original scattering dots by simulating on a computer is shown. It can reduce the cost of designing a light guide plate 30 by simulating the method on a computer, and then producing the light guide plate 30.

It is to be understood that the above-described embodiments are intended to illustrate rather than limit the disclosure. Variations may be made to the embodiments without departing from the spirit of the disclosure as claimed. The above-described embodiments illustrate the disclosure but do not restrict the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A method for designing a light guide plate, the method comprising the steps of:
(a) providing a raw light guide plate having a light input surface and a light output surface opposite to the light input surface;
(b) generating an illuminating surface having the same shape and area as that of the light output surface, dividing the illuminating surface into n×m illuminating areas, and dividing the light input surface into n×m scattering dots distributing areas corresponding to the n×m illuminating areas, wherein the ‘n’ and ‘m’ are integers indicating rows and columns, respectively;
(c) distributing original scattering dots on each scattering dots distributing areas; and
(d) optimizing the original scattering.

2. The method of claim 1, wherein the illuminating surface is the light output surface.

3. The method of claim 1, wherein the illuminating surface is an imaginary surface spaced apart from the light output surface.

4. The method of claim 3, wherein an orthographic projection of the illuminating surface overlaps the light output surface.

5. The method of claim 1, wherein a size of each of the scattering dots distributing areas is about the same.

6. The method of claim 1, wherein a shape of the scattering dots distributing areas is a square, rectangle or parallelogram.

7. The method of claim 1, where the ‘n’ and ‘m’ are 10.

8. The method of claim 1, wherein an orthographic projection of the n×m illuminating areas overlaps the n×m scattering dots distributing areas.

9. The method of claim 1, wherein the original scattering dots are distributed on the scattering dots distributing areas randomly.

10. The method of claim 1, wherein the original scattering dots are distributed on the scattering dots distributing areas uniformly.

11. The method of claim 1, wherein the original scattering dots are distributed to form a plurality of shapes concentrically located around a center of each of the scattering dots distributing areas.

12. The method of claim 1, wherein a step (e) of illuminating simulation is carried out before step (c) of distributing original scattering dots to determine the original illumination distribution of the illuminating surface.

13. The method of claim 1, wherein step (d) comprises the substeps of:
(d1) determining an illumination distribution of the illuminating surface;
(d2) evaluating; and
(d3) adjusting the original scattering dots on the corresponding scattering dots distributing areas according to the evaluation.

14. The method of claim 13, wherein step (d1) comprises the substeps of:
(d11) determining an illumination of each of the illuminating areas; and
(d12) calculating a mean value of the illumination and a difference in value between the mean value of the illumination and the illumination of each of the illuminating areas.

15. The method of claim 13, wherein adjusting the original scattering dots is performed by adding or reducing the number of original scattering dots.

16. The method of claim 13, wherein adjusting the original scattering dots is performed by changing a shape, size, or material of the original scattering dots.

17. The method of claim 13, wherein adjusting the original scattering dots is performed by moving the original scattering dots.

18. The method of claim 1, wherein the steps (a), (b), (c) and (d) are performed by simulations on a computer.
